(19) United States
(12) Patent Application Publication
(10) Pub. No.: US 2022/0101101 A1
(43) Pub. Date: Mar. 31, 2022

(54) DOMAIN ADAPTATION

(71) Applicant: Nokia Technologies Oy, Espoo (FI)

(72) Inventor: Akhil MATHUR, London (GB)

(21) Appl. No.: 17/468,069

(22) Filed: Sep. 7, 2021

(30) Foreign Application Priority Data
Sep. 11, 2020 (GB) 2014302.0

(51) Int. Cl. G06N 3/04; G06N 3/08; G06K 9/62

(52) U.S. Cl. CPC G06N 3/0454; G06N 3/08; G06K 9/628; G06K 9/6277; G06K 9/623

(57) ABSTRACT

This specification describes an apparatus relating to domain adaptation. The apparatus may comprise a means for providing a source dataset comprising a plurality of source data items associated with a source domain and a target dataset comprising a plurality of target data items associated with a target domain. The apparatus may also comprise means for providing a first computational model (34, 41) associated with the source domain dataset, the first computational model being associated with a plurality of source domain classes. The apparatus may also comprise means for generating, for each of a series of target data items xt input to the first computational model (34, 41), a target weight δT indicative of a confidence value that said target data item belongs to a class which is shared with known classes of the first computational model, and means for generating, for each of a series of source data items xs input to the first computational model (34, 41), a source weight δS indicative of a confidence value that said source data item belongs to a known class of the first computational model (34, 41), shared with the target domain. The apparatus may adapt at least part of the first computational model (34, 41) by means of one or more processors, to generate a second computational model by training a discriminator (42) to seek to decrease a discriminator loss function, the discriminator loss function being computed using the source and target data items xs xt, respectively weighted by the source and target weights δS, δT.

### FIELD

The present specification relates to domain adaptation, for example for adapting computational models for classifying data which may be received from one or more sensors.

### BACKGROUND

A computational model, e.g. provided on an encoder, may be trained using labelled training data, for example using the principles of machine learning. If data applied to such a computational model during a training phase has similar properties to data applied during a deployment phase, then high performing models can be provided. This is not always the case in real-world systems. There remains a need for further developments in this field.

### SUMMARY

The scope of protection sought for various aspects of the invention is set out by the independent claims. The aspects and features, if any, described in this specification that do not fall under the scope of the independent claims are to be interpreted as examples useful for understanding the various aspects of the invention.

According to a first aspect, this specification describes an apparatus, comprising means for: providing a source dataset comprising a plurality of source data items associated with a source domain; providing a target dataset comprising a plurality of target data items associated with a target domain; providing a first computational model (34, 41) associated with the source domain dataset, the first computational model being associated with a plurality of source domain classes; generating, for each of a series of target data items xₜ input to the first computational model (34, 41), a target weight δ^{T} indicative of a confidence value that said target data item belongs to a class which is shared with known classes of the first computational model; generating, for each of a series of source data items xₛ input to the first computational model (34, 41), a source weight δ^{S} indicative of a confidence value that said source data item belongs to a known class of the first computational model (34, 41), shared with the target domain; adapting at least part of the first computational model (34, 41) by means of one or more processors, to generate a second computational model by training a discriminator (42) to seek to decrease a discriminator loss function, the discriminator loss function being computed using the source and target data items xₛ xₜ, respectively weighted by the source and target weights δ^{S}, δ^{T}; and deploying the second computational model for use in receiving one or more input data items associated with the target domain for producing an inference output.

The source and target datasets may comprise respective first and second sets of audio data items, and wherein the second computational model is an adapted audio classifier comprising at least one class shared with known classes of the first computational model. The first set of audio data items may represent audio data received under one or more first conditions and wherein the second set of audio data items may represent audio data received under one or more second conditions, wherein the first and second conditions comprise differences in terms of their respective ambient noise and/or microphone characteristics. The first and second sets of audio data items may represent speech, e.g. one or more keywords.

The respective first and second sets of audio data items may represent speech in a particular language having different accents. The respective first and second sets of audio data items may represent speech received by people of different genders and/or age groups.

The second computational model may be configured for use with a digital assistant apparatus for performing one or more processing actions based on received speech associated with the target domain. The source and target datasets may comprise respective first and second sets of video data items, and wherein the second computational model may be an adapted video classifier comprising at least one class shared with known classes of the first computational model. The respective first and second sets of video data items may represent video data received under first and seconds conditions, wherein the first and second conditions may comprise differences in terms of their respective lighting, camera, and/or image capture characteristics. The first set of video data items may represent video data associated with movement of a first type of object and the second set of video data items may represent video data associated with movement of a second type of object.

The source and target datasets may comprise respective first and second physiological data items, received from one or more sensors, and wherein the second computational model may be an adapted health or fitness-related classifier comprising at least one class shared with known classes of the first computational model.

The means for generating the target weight and for generating the source weights may be configured to use a probability distribution produced by inputting one or more target data items to the first computational model. The apparatus may further comprise a first classifier means for computing the target weight, the first classifier means being a computational model trained using a filtered subset of target data items based on the produced probability distribution. The apparatus may be configured for providing the filtered subset of target data items by: generating, using the first computational model, a probability distribution over the known source domain classes for a particular target data item; determining a confidence level for the particular target data item belonging to a source domain class using the generated probability distribution; and selecting the particular target data item for the subset if the confidence level is above an upper confidence level threshold or below a lower confidence level threshold. The confidence level may be determined using the difference between the two largest values of the generated probability distribution. The first classifier means may be configured as a binary classifier for computing a target weight of ‘1’ for indicating that a particular target data item belongs to a shared target domain class and ‘0’ for indicating that a target data item belongs to a private target domain class. The apparatus may further comprise a second classifier means for computing the source weight, the second classifier means being a computational model trained using a filtered subset of the source domain data items.

The apparatus may be configured for filtering the source data items by: inputting a batch of target data items to the first trained model to generate respective probability distributions; aggregating the probability distributions; identifying a subset of the source domain classes based on the aggregated probability distributions, including a predetermined number of largest value and lowest value classes; and selecting source data items associated with the identified subset of source domain classes.

The second classifier means may be configured as a binary classifier for computing a source weight of ‘1’ for indicating that a particular source data item belongs to a known class of the first computational model shared with the target domain and ‘0’ for indicating that a particular source data item belongs to a private source domain class.

The first computational model may comprise a feature extractor associated with the source domain dataset, and wherein the means for adapting the first computational model comprises means for updating weights of the feature extractor based on the computed discriminator loss function. The first computational model may further comprise a classifier for receiving feature representations from the feature extractor, and wherein the means for adapting the first computational model further may comprise determining a classification loss resulting from updating weights of the feature extractor and further updating the weights of the feature extractor based on the classification loss.

The apparatus may further comprise means to enable adaptation of the first computational model automatically, responsive to identifying that one or more conditions under which the set of target data items were produced are different from one or more conditions under which the set of source data items were produced. The enabling means may be configured to identify different characteristics of one or more sensors used for generating the respective sets of target data items and source data items. The enabling means may be configured to access metadata respectively associated with the source and target data items indicative of the one or more conditions under which the sets of source and target data items were produced.

According to a second aspect, this specification describes a method, comprising: providing a source dataset comprising a plurality of source data items associated with a source domain; providing a target dataset comprising a plurality of target data items associated with a target domain; providing a first computational model (34, 41) associated with the source domain dataset, the first computational model being associated with a plurality of source domain classes; generating, for each of a series of target data items xₜ input to the first computational model (34, 41), a target weight δ^{T} indicative of a confidence value that said target data item belongs to a class which is shared with known classes of the first computational model; generating, for each of a series of source data items xₛ input to the first computational model (34, 41), a source weight δ^{S} indicative of a confidence value that said source data item belongs to a known class of the first computational model (34, 41), shared with the target domain; adapting at least part of the first computational model (34, 41) by means of one or more processors, to generate a second computational model by training a discriminator (42) to seek to decrease a discriminator loss function, the discriminator loss function being computed using the source and target data items xₛ xₜ, respectively weighted by the source and target weights δ^{S}, δ^{T}; and deploying the second computational model for use in receiving one or more input data items associated with the target domain for producing an inference output.

The source and target datasets may comprise respective first and second sets of audio data items, and wherein the second computational model may be an adapted audio classifier comprising at least one class shared with known classes of the first computational model. The first set of audio data items represent audio data received under one or more first conditions and wherein the second set of audio data items represent audio data received under one or more second conditions, wherein the first and second conditions comprise differences in terms of their respective ambient noise and/or microphone characteristics.

The first and second sets of audio data items may represent speech, e.g. one or more keywords. The respective first and second sets of audio data items may represent speech in a particular language having different accents. The respective first and second sets of audio data items may represent speech received by people of different genders and/or age groups.

The second computational model may be for use with a digital assistant apparatus for performing one or more processing actions based on received speech associated with the target domain.

The source and target datasets may comprise respective first and second sets of video data items, and wherein the second computational model may be an adapted video classifier comprising at least one class shared with known classes of the first computational model.

The respective first and second sets of video data items may represent video data received under first and seconds conditions, wherein the first and second conditions may comprise differences in terms of their respective lighting, camera, and/or image capture characteristics. The first set of video data items may represent video data associated with movement of a first type of object and the second set of video data items represent video data associated with movement of a second type of object. The source and target datasets may comprise respective first and second physiological data items, received from one or more sensors, and wherein the second computational model may be an adapted health or fitness-related classifier comprising at least one class shared with known classes of the first computational model.

Generating the target and source weights may use a probability distribution produced by inputting one or more target data items to the first computational model. The method may further comprise using a first classifier for computing the target weight, the first classifier being a computational model trained using a filtered subset of target data items based on the produced probability distribution. The filtered subset of target data items may be obtained by: generating, using the first computational model, a probability distribution over the known source domain classes for a particular target data item; determining a confidence level for the particular target data item belonging to a source domain class using the generated probability distribution; and selecting the particular target data item for the subset if the confidence level is above an upper confidence level threshold or below a lower confidence level threshold. The confidence level may be determined using the difference between the two largest values of the generated probability distribution.

The first classifier may be configured as a binary classifier for computing a target weight of ‘1’ for indicating that a particular target data item belongs to a shared target domain class and ‘0’ for indicating that a target data item belongs to a private target domain class. The method may further comprise using a second classifier for computing the source weight, the second classifier being a computational model trained using a filtered subset of the source domain data items. Source data items may be filtered by: inputting a batch of target data items to the first trained model to generate respective probability distributions; aggregating the probability distributions; identifying a subset of the source domain classes based on the aggregated probability distributions, including a predetermined number of largest value and lowest value classes; and selecting source data items associated with the identified subset of source domain classes.

The second classifier may be configured as a binary classifier for computing a source weight of ‘1’ for indicating that a particular source data item belongs to a known class of the first computational model shared with the target domain and ‘0’ for indicating that a particular source data item belongs to a private source domain class.

The first computational model may comprises a feature extractor associated with the source domain dataset, and wherein the means for adapting the first computational model may comprise means for updating weights of the feature extractor based on the computed discriminator loss function. The first computational model may further comprise a classifier for receiving feature representations from the feature extractor, and wherein adapting the first computational model further comprises determining a classification loss resulting from updating weights of the feature extractor and further updating the weights of the feature extractor based on the classification loss.

The method may further comprise performing adaptation of the first computational model automatically, responsive to identifying that one or more conditions under which the set of target data items were produced are different from one or more conditions under which the set of source data items were produced. Adaptation may be performed responsive to identifying different characteristics of one or more sensors used for generating the respective sets of target data items and source data items. The method may further comprise accessing metadata respectively associated with the source and target data items indicative of the one or more conditions under which the sets of source and target data items were produced.

According to a third aspect, this specification describes a method computer program comprising computer-readable instructions, which, when executed by a computing apparatus, causes the computer apparatus to perform any method as described with reference to the second aspect.

According to a fourth aspect, this specification describes an apparatus comprising: at least one processor; and at least one memory including computer program code which, when executed by the at least one processor, causes the apparatus to perform any method as described with reference to the second aspect.

### BRIEF DESCRIPTION OF THE FIGURES

Examples will now be described, by way of example only, with reference to the accompanying drawings, in which:

FIG. 1A is a block diagram of an example system;

FIG. 1B is a block diagram of an example system;

FIG. 2 is a flow chart showing operations of an algorithm in accordance with an example aspect;

FIG. 3 is a block diagram of an adaptation apparatus in accordance with an example aspect;

FIG. 4 is a is a schematic block diagram of at least some components of the FIG. 3 adaptation apparatus;

FIG. 5 is a flow chart showing in greater detail operations of an an algorithm in accordance with an example aspect;

FIG. 6 is a flow chart showing operations of another algorithm in accordance with an example aspect;

FIG. 7 is a schematic diagram of a probability distribution, useful for understanding example aspects;

FIG. 8 is a block diagram of a component of the FIG. 3 apparatus;

FIG. 9 is a flow chart showing operations of another algorithm in accordance with an example aspect;

FIG. 10 is a schematic diagram of a probability distribution, useful for understanding example aspects;

FIG. 11 is a block diagram of another component of the FIG. 3 apparatus;

FIG. 12A indicates a schematic diagrams indicating how particular loss functions may be used iteratively to update weights of respective models in accordance with an example aspect;

FIG. 12B indicates a schematic diagram indicating how particular loss functions may be used iteratively to update weights of respective models in accordance with an example aspect;

FIG. 12C indicates a schematic diagram indicating how particular loss functions may be used iteratively to update weights of respective models in accordance with an example aspect;

FIG. 12D indicates a schematic diagram indicating how particular loss functions may be used iteratively to update weights of respective models in accordance with an example aspect;

FIG. 12E indicates a schematic diagram indicating how particular loss functions may be used iteratively to update weights of respective models in accordance with an example aspect;

FIG. 12F indicates a schematic diagram indicating how particular loss functions may be used iteratively to update weights of respective models in accordance with an example aspect;

FIG. 13 is a schematic block diagram of one hardware architecture for using the FIG. 3 adaptation apparatus;

FIG. 14 is a schematic block diagram of an alternative hardware architecture for using the FIG. 3 adaptation apparatus;

FIG. 15 is a block diagram of a neural network system in accordance with an example aspect;

FIG. 16 is a block diagram of components of a system in accordance with an example aspect; and

FIG. 17 is a diagram, which is useful for understanding example aspects.

### DETAILED DESCRIPTION

In the description and drawings, like reference numerals refer to like elements throughout.

Example aspects relate to domain adaptation in the field of machine learning, for example for the purpose of mitigating so-called domain shift which can lead to performance degradation in practical implementations as will be explained below.

Example aspects may relate to domain adaption for one or more specific technical purposes, for example relating to computational models for classifying data items which represent, or are generated by, real-world and/or technical entities, such as one or more electrical or electronic sensors. A sensor may comprise one or more of a microphone, camera, video camera, light sensor, heat sensor, geospatial positioning sensor, orientation sensor, accelerometer and a physiological sensor such as for estimating heart rate, blood pressure, temperature, an electrocardiogram (ECG) or the like. Specific examples may include one or more of (i) classifying audio data (e.g. music or speech), (ii) classifying video data (e.g. data representing captured images of people or objects) (iii) classifying technical or physiological performance data (e.g. representing health or fitness-related data derived from one or more body-worn sensors) and (iv) classifying data from one or more sensors associated with industrial machinery or processes. All such examples, as well as others, are susceptible to so-called domain shift, as will be explained below.

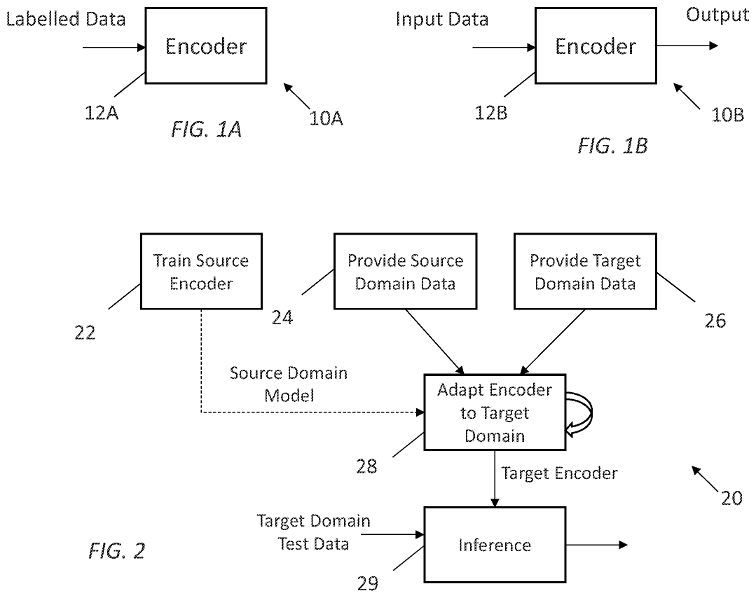

FIG. 1A is a block diagram of an example system, indicated generally by the reference numeral 10A. The system 10A comprises an encoder 12A having an input that is receiving labelled data. The labelled data is used for training the encoder 12A using machine-learning principles, for example supervised learning principles. The encoder 12A may comprise a computer or a digital system which may comprise one or more processors and/or controllers. The encoder 12A may be provided and trained on a single system or may be distributed over multiple systems. The encoder 12A may implement a computational model, e.g. a software program, having a trained function.

FIG. 1B is a block diagram of an example system, indicated generally by the reference numeral 10B. The system 10B comprises an encoder 12B that is a trained version of the encoder 12A (e.g. trained using the labelled data of FIG. 1A). The encoder 12B receives an input and generates an output based on the trained function of the encoder. This may be referred to as inference output.

Machine Learning (ML) algorithms, as data-driven computational methods, typically attempt to fit a complicated function over a labelled dataset, e.g. a set of training data, with the expectation that comparable performance will be achieved when an unseen dataset, e.g. test data or operational data, is applied to the trained algorithm. Such training algorithms may be referred to as supervised learning algorithms in which a labelled training set is used to learn a mapping between input data and class labels.

In both theory and practice, machine learning and supervised learning methodologies typically assume that the data distributions of training datasets and deployment (e.g. testing) datasets are the same. Thus, in the example systems 10A and 10B, it may be assumed that the distribution of the input data of the system 10B matches the distribution of the labelled data in the system 10A. The labelled data and the input data are said to belong to the same domain.

Following this assumption, labelled training sets may be provided for each of a plurality of data distributions, even though many of these data distributions may be similar. Example sets of data for which separate labelled training data might be generated include images of the same object from different angles, paintings in different styles, human activity sensors in different body locations, processing of the same language with different accents and so on.

In real-world systems, the assumption that the data distributions of training datasets and deployment (e.g. testing) datasets are the same is not always valid.

A number of real-world factors may lead to variability between training and test data distributions. These factors could include, for example, variabilities induced by sensor processing pipelines, by environment factors, e.g., lighting conditions, by user-related issues e.g., different people wear their smart devices differently, and/or by audio data representing speech being from users with different accents. This shift in data distribution between training domains and testing/deployment domains is sometimes referred to as “domain shift”.

As discussed further below, “domain adaptation” seeks to address the issue of domain shift. In general, domain adaptation provides two similar (but different) domains, referred to herein as a source domain and a target domain. Data instances in the source domain are typically labelled (providing labelled training data for a source model), whereas data instances in the target domain are partially labelled (semi-supervised domain adaption) or not labelled at all (unsupervised domain adaption). The aim of domain adaption is to seek to train a target model, e.g. another encoder, by utilizing aspects of the source model.

Thus, instead of training each data distribution (or “domain”) from scratch, domain adaptation seeks to develop a target model by adapting an already-trained source model. This can lead to a reduction in labelling efforts, thereby providing processing and memory efficiencies, and, in some circumstances, to the development of more robust models. However, adaptation merely by aligning feature representations of source datasets to a target datasets without accounting for the existence of non-shared private classes in one or both domains can have negative consequences, even leading to a worse performance than if no adaptation were performed.

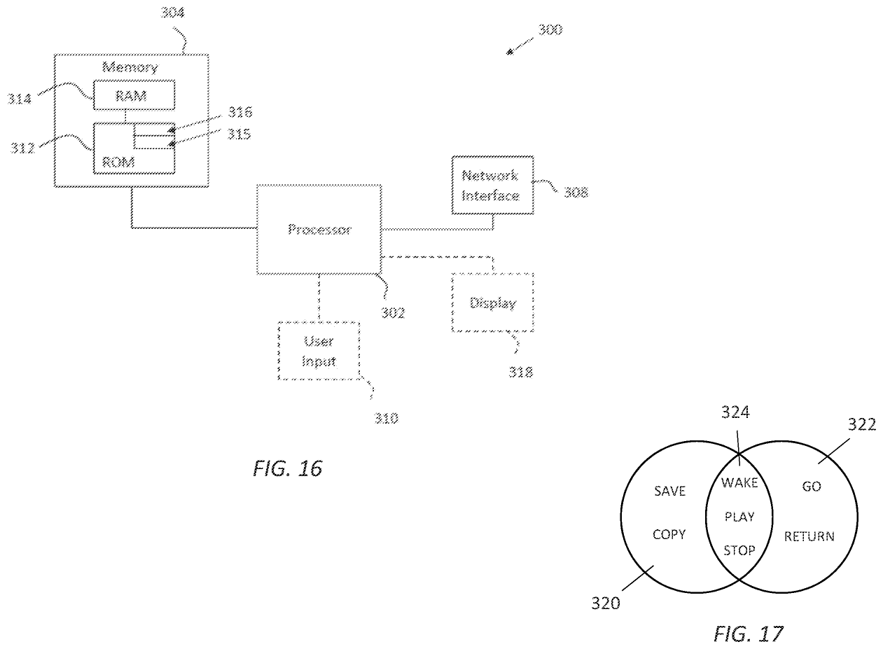

To illustrate, FIG. 17 is a Venn diagram representing keywords of a speech recognition model in both a source domain 320 and a target domain 322. The speech recognition model of the source domain 320 may be used with a computerized digital assistant application. The source domain 320 may employ a computational model trained to identify the one or more keywords SAVE, COPY, WAKE, PLAY and STOP, e.g. for controlling some application. Said one or more keywords may be represented by labelled classes of the computational model. The target domain 322, for use with the same, or a different computerized digital assistant application, may require a computational model trained to identify the one or more keywords WAKE, PLAY, STOP, GO and RETURN.

Clearly, area 324 identifies the shared classes between the source and target domains 320, 322 including WAKE, PLAY and STOP. The source domain 320 has private classes SAVE and COPY and the target domain 322 has private classes GO and RETURN. Example aspects aim to distinguish, as part of an iterative training process, those classes that are shared and private among the source and target domains 320, 322 in order to provide a more robust adaptation.

FIG. 2 is a flow chart showing an algorithm, indicated generally by the reference numeral 20, useful for understanding some example aspects.

The algorithm 20 starts at operation 22, where a source encoder is trained at some earlier point to provide a source domain model. The source encoder may, for example, be trained using labelled training data, as described above with reference to FIG. 1A, in a supervised learning manner, for example, by any artificial neural network model, such as a convolutional neural network (CNN).

The source encoder when trained represents a computational model which may be referred to as a source domain model. The source domain model may be usable in a subsequent inference phase for generating output data representing, for example, a prediction of a class that the input or test data belongs to. The source domain model may, for example, include one or more sub-models including a feature extractor for generating feature representations of input data, and a classifier.

At a later time, when adaptation of the source domain model is required for use with target domain data, respective operations 24 and 26 provide source domain data and target domain data. Source domain data may comprise one or more data items of a source domain dataset which corresponds (or closely corresponds) to that used to train the source domain model. For example, speech data from users with the same or closely similar accents. Operations 24 and 26 may be performed in parallel or in any order.

At operation 28, the source domain model may be adapted as described herein using the provided source and target domain data as training data. For example, a feature extractor and/or classifier may be iteratively updated (indicated by arrow) based on sequences of source and target domain data items. The feature extractor and/or classifier may be considered as sub-models, having their own parameters or weights. Updating may involve determining updated parameters or weights. The aim is to ‘align’ or shift the source domain model so that it can be used in an inference operation 29 later on, for example in which the adapted model is deployed (i.e. made effective for inference purposes) on an encoder for receiving target domain test data, which may be received from one or more sensors either directly or indirectly in real-time or near real-time. Note that, in some example aspects, the source domain model need not comprise a copy of the comprehensively trained source domain model on the source encoder 22 for adaptation, although this is one option.

Rather, another form of source domain model may comprise a set of arbitrary, e.g. random or pseudo-random, parameters, initialized based on the source domain model to have the same trained classes. As the operations disclosed herein are performed, the target domain model initialized in this way should converge as described.

As used herein, the term “provide” may also comprise “receive” or “generate”.

Example aspects may involve adapting the source domain model to provide a target domain model, which may include estimating so-called shared classes which are known classes of the source domain model that at least some of the target domain data also belong to. Example aspects may involve adapting those classes to have more significant weights as opposed to those of non-shared classes so that subsequent inputs relating to private can be identified and labelled appropriately, e.g. as unknown.

One way to perform adaptation is to align feature representations of the source and target domains; that is the feature representations of subsequent target data items are aligned or shifted by training a feature extractor so that a downstream classifier will maps the shifted feature representation of a given target data item to the correct class if it is a shared class. For source domain classes not represented in the target domain data, and vice versa, it is proposed that the adaptation process may not align. For this purpose, we estimate one or more private classes.

In overview, therefore, example aspects aim to estimate shared and private classes and appropriately weight their contribution in the adaptation process to counter so-called label mismatch. In the inference phase, test data associated with a private class can be classified as unknown. In this way, known issues associated with negative transfer, whereby an adapted model may perform worse than the original model, may be avoided. Also, by determining certain data items to be within a private class, and labelling them as unknown, we reduce the risk that data items be incorrectly labelled with a source domain class. This can seriously affect performance of subsequent applications reliant on class labels to perform operations.

Example aspects relate to training a second computational model by adapting a first, already trained computational model associated with a source domain. The second computational model may be initialized using the first computational model and thereafter iteratively adapted using a weighted loss function that uses target and source weights to indicate a confidence level that a particular target and source data item belongs to a shared class. A higher confidence level is so indicative, whereas a lower confidence level is indicative of the particular data item belonging to a private class.

In example aspects, there may be provided source data items Xₛ and labels Yₛ, sampled from a probability distribution S, and target data items Xₜ sampled from a probability distribution T. No labels are available from the target domain during training. We may denote the label sets of the source and target domains as C_{S} and C_{T} respectively. The set of classes shared between source and target domains may be denoted by C_{Shared} Finally, C′_{S} and C′_{T} may represent private label sets of the source and the target domains.

The algorithm 20 may be implemented, comprising one or more processors or controllers under computer program control for performing operations described herein, for example, an apparatus comprising at least one processor, and at least one memory including computer program code, the at least one memory and the computer program code configured to, with the at least one processor, cause the apparatus at least to perform defined functions and/or operations.

FIG. 3 shows in schematic view of an adaptation system 30 according to some example aspects. The adaptation system 30 may be provided as a standalone system or as part of a source system or target system. The target system may comprise an edge device, for example, a client device, end-user device or an IoT (Internet of Things) device. If provided as part of a source system, source domain data items X_{S} may be stored locally and a target dataset of target domain data items Xₜ may be received either directly or indirectly from a target system. In some aspects, the adaption system 30 may be provided in the cloud, e.g. a cloud space, such as one or more server devices, associated with the source system. In some aspects, the adaptation system 30 may be provided as part of a target system whereby the target domain data items X_{T} may be stored locally and the source domain data items X_{S} may be received either directly or indirectly form the source system. The latter has security benefits in that the target domain data items Xₜ may be kept private.

In some example aspects, the adaptation system 30 may be enabled or triggered to perform the adaptation operations described herein, automatically, responsive to identifying that one or more conditions under which the target data items Xₜ were received are different from one or more conditions under which the source data items Xₛ are or were received.

For example, a source or target computer system, or any system associated with the adaptation system 30, may store source model metadata indicative of one or more characteristics of one or more sensors used for generating the source data items. If the corresponding one or more characteristics of sensors used for generating the target data items are different, or different beyond a predetermined threshold in terms of values, then the adaptation system 30 may be enabled. For example, in the cause of audio or video data, the characteristics may relate to particular models or types of microphone or camera; if a first type or model is used to capture the source data items X_{S} and a second type or model is used to capture the target data items Xₜ then the identified difference may be sufficient to trigger model adaptation by the adaptation system 30. In some aspects, other characteristics such as time or date of capture, lighting conditions, ambient noise conditions, and so on may be parameterized and stored as source model metadata for use in subsequently determining if and when to enable or trigger the adaptation system 30 based on corresponding characteristics identified for the target data items Xₜ.

The adaptation system 30 may comprise a sampling subsystem 32, a feature extraction subsystem 34 and an adaptation subsystem 36 according to example aspects.

The sampling subsystem 32 is optional and may be configured to, for example, resample time-varying data to a particular frequency, or, in the case of image data, resize the images.

The feature extraction subsystem 34 may be configured to perform feature extraction using any known means, for example to extract statistical features such as mean, variance and/or task-specific features such as Mel-Frequency Cepstral Components (MFCC) for speech models.

The adaptation subsystem 36 may be configured to perform adaptation of, or based on, an already-trained source domain model to produce a target domain model, as described herein.

The adaptation system 30 may comprise one or more processors or controllers under computer program control for performing operations described herein, for example, an apparatus comprising at least one processor, and at least one memory including computer program code, the at least one memory and the computer program code configured to, with the at least one processor, cause the apparatus at least to perform defined functions and/or operations.

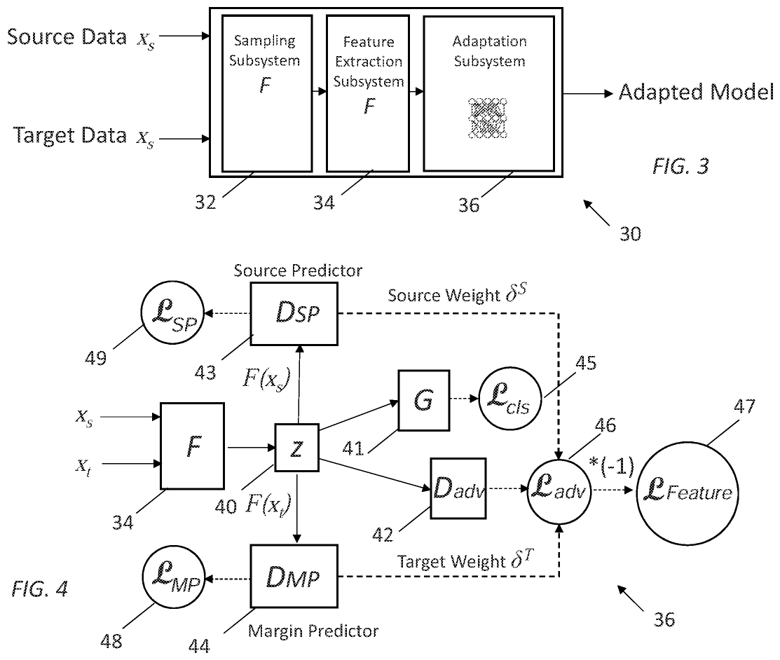

FIG. 4 is a schematic block diagram of at least some components of the adaptation subsystem 36. The adaptation subsystem 36 may comprise a greater or fewer number of components and may be implemented using hardware, software, firmware or any combination thereof. The adaptation subsystem 36 may be implemented, comprising one or more processors or controllers under computer program control for performing operations described herein, for example, an apparatus comprising at least one processor, and at least one memory including computer program code, the at least one memory and the computer program code configured to, with the at least one processor, cause the apparatus at least to perform defined functions and/or operations.

In terms of its implementation on hardware, the components may be distributed so that certain functions are performed on one item of hardware and other functions are performed on one or more other items of hardware. The different items of hardware need not be local to one another, and certain intercommunications may be performed over one or more data networks between one or more remote locations.

The feature extraction subsystem 34 is shown as part of the FIG. 4 diagram for convenience and will hereafter be referred to simply as the feature extractor 34.

The feature extractor 34 is a computational model for generating a meaningful feature representation z=F(x) 40 for training and inference purposes. As a computational model, the feature extractor 34 may therefore comprise a set of parameters or weights W_{F} which can be iteratively adjusted (trained) according to a loss function as part of, for example, a gradient descent algorithm to reduce or minimize the loss function.

During adaptation, both target and source data items Xₜ, and X_{S} may be provided to the feature extractor 34.

Part of adapting the source domain model may comprise adapting a copy of its feature extractor by modifying weights W_{F} such that target data items Xₜ result in feature representations more aligned with source data items belonging having a shared class C_{Shared}.

The adaptation subsystem 36 may also comprise a classifier 41. The classifier 41 may be a probabilistic classifier and may also comprise a computational model for generating, from received feature representations z from the feature extractor 34, a probability distribution ŷ over a set of classes. As a computational model, the classifier 41 may therefore comprise a set of parameters or weights W_{G} which can be iteratively adjusted (trained) according to a classifier loss function L_{cls} 45 as part of, e.g. a gradient descent algorithm, to reduce or minimize the classifier loss function.

For example, part of adapting the source domain model may comprise adapting a copy of its classifier by modifying weights W_{G} such that target data items Xₜ produce from the classifier 41 a probability distribution whereby target data items Xₜ produce higher probability values for a shared class C_{Shared}. The probability distribution ŷ may comprise a SoftMax probability distribution.

The adaptation subsystem 36 may also comprise a discriminator 42 for adversarial learning. The discriminators 42 are used in generative adversarial networks (GANs) and comprise a computational model for training, from received feature representations z, data indicative of whether a particular data item is associated with the source domain or some other domain, for example the target domain. An aim of the discriminator 42 is to separate source features from target features by said adversarial learning. As a computational model, the discriminator 42 may therefore comprise a set of parameters or weights W_{adv} which can be iteratively adjusted (trained) according to an adversarial loss function L_{adv} 46 as part of, e.g. a gradient descent algorithm, to reduce or minimize the adversarial loss function.

With knowledge of the value of L_{adv} 46 as training progresses iteratively, the discriminator 42 can be iteratively updated to improve separation of the source and target features. Further, by reversing the L_{adv} 46 gradient by multiplying it by minus 1, we obtain a reverse gradient representing feature loss L_{Feature} 47.

L_{Featute} 47 may be used to update the weights W_{F} of the feature extractor 34 in order to bring source and target feature representations closer together as part of the above-mentioned feature alignment. However, as noted above, this is desirable only for the feature representations associated with shared classes as opposed to for private classes.

Therefore, as part of the feature alignment process, the adaptation subsystem 36 is configured to place a higher importance or weight on shared classes in the feature alignment process than on private classes. Thus, the adversarial loss function L_{adv} 46 that the discriminator 42 acts to minimize is formulated to include first and second weighting terms δ^{S} and δ^{T}, respectively referred to as source and target weights.

For example, the adversarial loss function L_{adv} 46 may take the form:

$${ℒ}_{adv} = - {𝔼}_{{x}_{s} ∼ S} [ {δ}^{S} ( {x}_{s} ) log ( {D}_{adv} ( F ( {x}_{s} ) ) ] - {𝔼}_{{x}_{t} ∼ T} [ {δ}^{T} ( {x}_{t} ) log ( 1 - {D}_{adv} ( F ( {x}_{t} ) ) ] \qquad ( 1 )$$

where δ^{S} and δ^{T} are weights assigned to source and target data items respectively.

By assigning higher weights to data items from shared classes and lower weights to data items from private classes in the relevant domain, the adaptation process may be improved.

Referring back to FIG. 4, two computational classifier models are provided in the form of a source predictor 43 and a margin predictor 44. The source predictor 43 and margin predictor 44 are configured to generate the abovementioned source and target weights δ′ and δ^{T}.

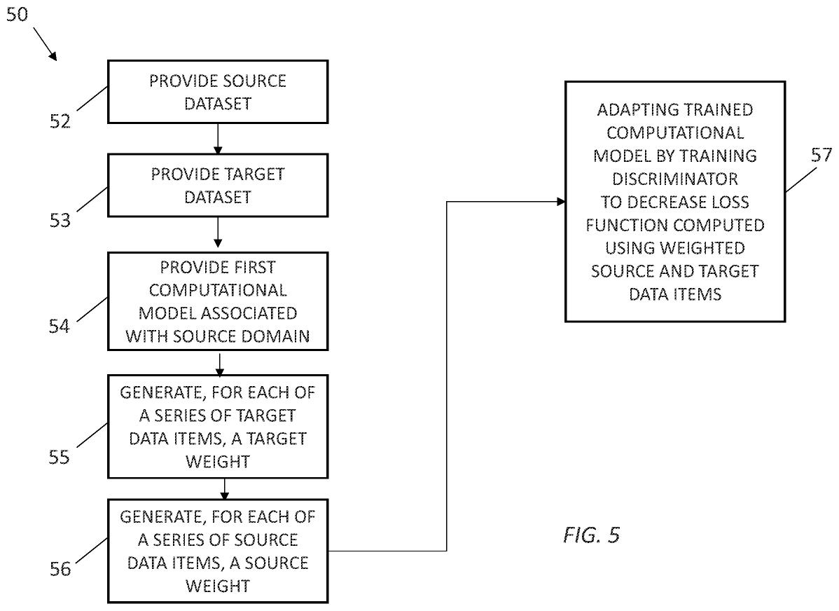

FIG. 5 is a flow diagram showing at a high level processing operations 50 that may be performed in accordance with example aspects.

An operation 52 may comprise providing a source dataset comprising a plurality of source data items Xₛ associated with a source domain.

An operation 53 may comprise providing a target dataset comprising a plurality of target data items Xₜ associated with a target domain.

An operation 54 may comprise providing a first computational model associated with the source domain dataset. The first computational model may comprise a dataset or file defining nodes and parameters (e.g. weights) that may be transferred from one computational item, e.g. an encoder, to another. In some example aspects, the first computational model may be a trained computational model. Alternatively, in some example aspects, the first computational model may be a model initialized with random or pseudo-random parameters but having the same source domain classes associated with the source domain dataset as previously trained.

It should be appreciated that the operations 52, 53, 54 may be performed in parallel, substantially simultaneously or in any order.

An operation 55 may comprise generating, for each of a series of target data items Xₜ input to the first computational model, a target weight. The target weight may be indicative of a confidence value that said target data item belongs to a known class of the first computational model.

An operation 56 may comprise generating, for each of a series of source data items X_{S} input to the first computational model, a source weight. The source weight may be indicative of a confidence value that said source data item belongs to a known class of the first computational model shared with the target domain.

It should be appreciated that the operations 55, 56 may be performed in parallel, substantially simultaneously or in any order.

An operation 57 may comprise adapting the first trained computational model to generate a second computational model by training a discriminator to seek to decrease a discriminator loss function, the discriminator loss function being computed using the source and target data items, respectively weighted by the source and target weights, for example as in (1).

The operations 52-57 may be performed on any of hardware, software, firmware or any combination thereof, for example, the operations be implemented, comprising one or more processors or controllers under computer program control for performing operations described herein, for example, an apparatus comprising at least one processor, and at least one memory including computer program code, the at least one memory and the computer program code configured to, with the at least one processor, cause the apparatus at least to perform defined functions and/or operations.

As will become clear, the means for generating the target weight and for generating the source weight may be configured to use a probability distribution produced by inputting one or more target data items to the first computational model.

Example methods for generating target and source weights δ^{T}, δ^{S} will now be described.

Determining Target Weights δ^{T}

Referring back to FIG. 4, a target data item Xₜ may be input to the feature classifier to produce a feature representation, then fed to the classifier 41. The classifier may generate a probability distribution ŷ=G(F(x_{T})) over the source class set C_{S}, e.g. in the form of SoftMax outputs.

It is assumed that the classifier 41 will be more confident in its predictions for target data items Xₜ from shared classes C_{Shared} as compared to those from the private classes C′_{T}. This is reasonable because, despite the presence of domain shift, classes in C_{Shared} are likely to be closer to the source domain as compared to private classes C′_{T}. Hence, a measure of classifier confidence can be derived as a weighting function to separate shared and private target classes during adaptation using the discriminator 46.

A so-called Maximum Margin (MM) method may be used as a criterion for classifier confidence. Formally, a Margin M may be defined as the difference between the top two SoftMax outputs in the probability distribution ŷ. When the classifier 41 has high confidence about its top prediction, M will be high. On the contrary, when the classifier 41 is less confident, M will be low. However, due to the presence of domain shift between the source and target domains, the margin M obtained on target data items could be noisy and may lead to incorrect target weights δ^{T}.

In example aspects, rather than using the margins M or class probabilities directly, adaptation subsystem 36 is configured to filter target data items with very high (and very low) margins M for training another form of classifier model, namely the margin predictor 44 mentioned above. Target data items Xₜ from private target classes (that will have both covariate shift and no sematic overlap with source classes (i.e., concept shift)) are likely to have very low margins. On the contrary, target data items Xₜ from shared target classes (that will only have covariate shift, but no concept shift) are likely to have higher margins M. Hence, by filtering the target data items Xₜ and training the margin predictor 44 based on the filtered target data items, we can derive better target weights δ^{T} for the adversarial loss function L_{adv} 46.

In some aspects, the margin predictor 44 may be configured as a binary classifier, outputting a “1” for high probability of belonging to a shared target class and a “0” for a low probability.

FIG. 6 is a flow diagram showing at a high level processing operations 60 that may be performed in accordance with filtering target data items for training the margin predictor 44.

An operation 62 may comprise providing a data item Xₜ from the target dataset.

An operation 63 may comprise generating, using the first computational model, a probability distribution ŷ over the known source domain classes for a particular target data item.

An operation 64 may comprise determining a confidence level (M) for the particular target data item belonging to a source (i.e. shared) domain class using the generated probability distribution; and

An operation 65 may comprise selecting the particular target data item for the subset if the confidence level (M) is above an upper confidence level threshold or below a lower confidence level threshold.

The operations 62-65 may be performed on any of hardware, software, firmware or any combination thereof, for example, the operations may be implemented, comprising one or more processors or controllers under computer program control for performing operations described herein, for example, an apparatus comprising at least one processor, and at least one memory including computer program code, the at least one memory and the computer program code configured to, with the at least one processor, cause the apparatus at least to perform defined functions and/or operations. The one or more processors or controllers may include one or more processing units, such as graphical processing units (GPUs).

In more detail, for a batch of target data items input into the training pipeline represented in FIG. 4, a margin M is computed for each data item or sample. The margin M is one way of estimating confidence. Target data items xₜ^{high} with very high margins (above an upper threshold) and data items xₜ^{low} with very low margins (below a lower threshold) may then be used to train a binary classifier which we refer to as the margin predictor 44. The upper and lower thresholds are separated in order that margins that are neither particularly high nor particularly low are filtered out. By using “1” as the label for xₜ^{high} and “0” as the label for xₜ^{low}, a loss function L_{MP} 48 can be formulated as:

$${ℒ}_{MP} = {𝔼}_{x ∼ {x}_{t}^{high}} [ {L}_{BCE} ( {D}_{MP} ( F ( x ) ) , 1 ] + {𝔼}_{x ∼ {x}_{t}^{low}} [ {L}_{BCE} ( {D}_{MP} ( F ( x ) ) , 0 ] \qquad ( 2 )$$

where L_{BCE} denotes the Binary Cross-Entropy Loss. The margin predictor 44 may be iteratively trained to reduce L_{MP} 48.

As is evident, the margin predictor 44 may be trained to predict “1” when it is fed a target data item xₜ^{high} with high margin (i.e., high confidence in prediction) and “0” when it encounters a data item xₜ^{low} with low margin (i.e., low confidence in prediction). Therefore, the output of the margin predictor 44 may be used directly for the target weight δ^{T} as it satisfies the weighting criterion of shared and private classes.

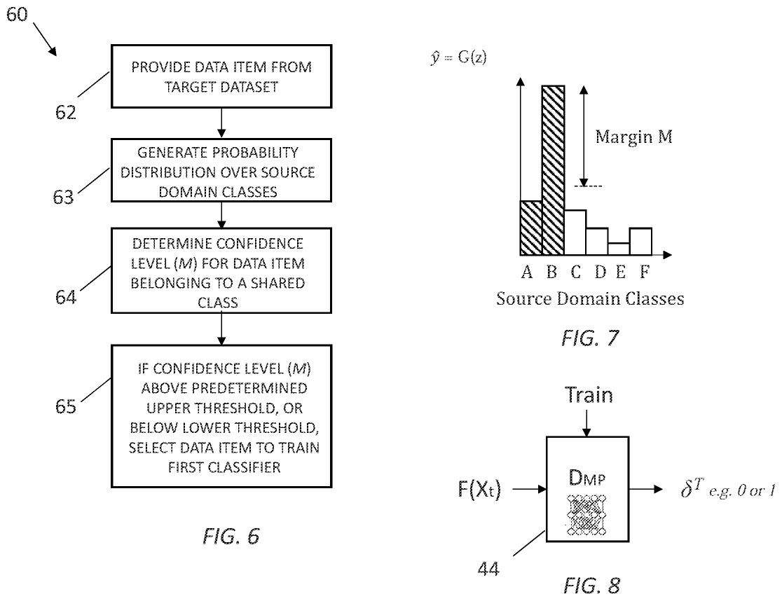

Merely for illustration, FIG. 7 indicates a representative probability distribution ŷ=G(F(xₜ)) for a notional target data item xₜ when applied to the classifier 41. In this case, the two highest values correspond to classes “B” and “A” and hence the margin M can be determined, e.g. 0.76 to take an example value. If the upper threshold is, say, 0.7 and the lower threshold is 0.2, then the particular data item xₜ may be selected to train the margin predictor 44 with the label “1” or similar. Conversely, were the margin M a lower value of, say, 0.12, then the data item is selected to train the margin predictor 44 with the label “0” or similar. If the margin M is between the upper and lower thresholds, e.g. 0.28, then the data item is not used for training the margin predictor 44.

FIG. 8 is a block diagram of an example margin predictor 44. It may comprise a form of classifier computational model that is iteratively trained and, based in an input F(Xₜ) generates a target weight δ^{T} in the manner described above.

The margin predictor 44 may be implemented, comprising one or more processors or controllers under computer program control for performing operations described herein, for example, an apparatus comprising at least one processor, and at least one memory including computer program code, the at least one memory and the computer program code configured to, with the at least one processor, cause the apparatus at least to perform defined functions and/or operations.

Determining Source Weights δ^{S}

In example aspects, the source weights δ^{S} are determined based on another property of the probability distribution ŷ. Particularly, it is noted that source classes C_{Shared} which are shared with the target domain will have higher probabilities in ŷ and the private source classes C′_{S} will have lower probabilities. This is reasonable because target data Xₜ has no overlap with private source classes, and hence the classifier 41 should estimate low probabilities for C′_{S}.

Thus, by observing the probability distribution ŷ over source classes, it is possible to distinguish shared and private source classes and assign appropriate weights to them also. However, once again, due to domain shift and the presence of private classes, these class probabilities tend to be noisy.

Hence, example aspects follow a similar approach which may include filtering source domain data items xₛ with class probabilities at the extremes (e.g. top-K classes and bottom-K classes) and then training another form of classifier model, namely the source predictor 43, to predict whether a source data item xₛ belongs to one of the shared classes or private classes.

For each target data item Xₜ in a batch B, we may compute class probabilities yᵢ=G(xₜⁱ)) and average them over the entire batch to obtain a mean class probability vector η.

$$η = \frac{1}{\vert B \vert} {\sum }_{i = 1}^{\vert B \vert} {\hat{y}}_{t}^{i} \qquad ( 4 )$$

Then, we may obtain those classes with extreme per-class probabilities (e.g. the top-K and bottom-K classes) by analyzing per-class probabilities in η. This process filters-out potentially noisy classes and provides us with a more robust estimate for C_{Shared}.

Having identified the top-K and bottom-K classes, source data items Xₛ belonging to these classes may be used to train the source predictor 43.

In some aspects, the source predictor 43 may be configured as a binary classifier. A label “1” may be allocated to data items from the top-K classes and a label “0” to the bottom-K classes. The source predictor 43 can be iteratively trained to reduce L_{SP} 49 as follows:

$${ℒ}_{SP} = {𝔼}_{x ∼ {x}_{s}^{top}} [ {L}_{BCE} ( {D}_{S P} ( F ( x ) ) , 1 ] + {𝔼}_{x ∼ {x}_{s}^{bottom}} [ {L}_{BCE} ( {D}_{S P} ( F ( x ) ) , 0 ] \qquad ( 4 )$$

As is evident, the source predictor 43 is trained to predict “1” for source data items in C_{Shared} and “0” for those in private classes C′_{S}.

The outputs of the source predictor 43 may be used as the source weights δ^{S}.

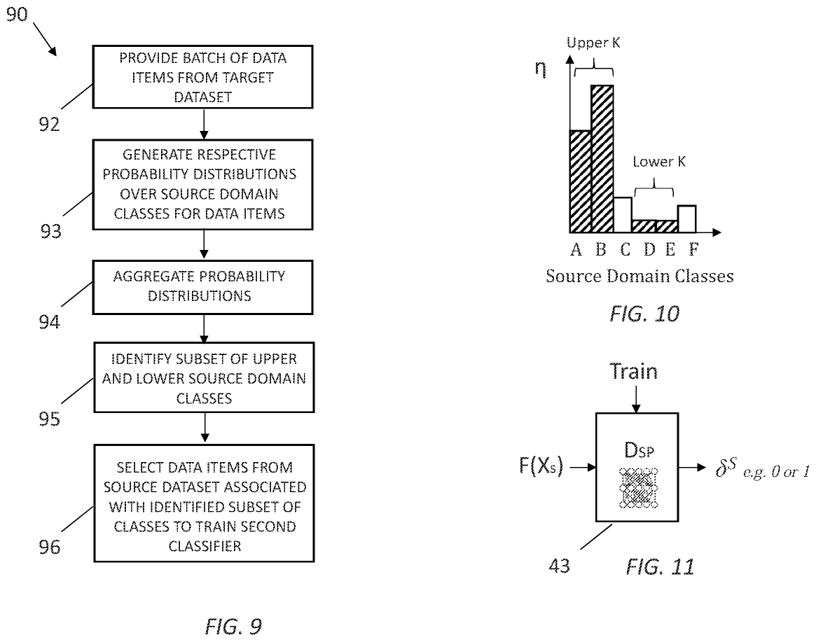

FIG. 9 is a flow diagram showing at a high level processing operations 90 that may be performed in accordance with filtering target data items for training the source predictor 43.

An operation 92 may comprise providing a batch B of data item Xₜ from the target dataset.

An operation 93 may comprise generating respective probability distributions ŷ over the source domain classes.

An operation 94 may comprise aggregating the probability distributions ŷ, e.g. averaging them over the batch B.

An operation 95 may comprise identifying a subset of the source domain classes based on the aggregated probability distributions, including a predetermined number of largest value and lowest value classes.

An operation 96 may comprise selecting source data items associated with the identified subset of source domain classes for training the source predictor 43.

The operations 92-96 may be performed on any of hardware, software, firmware or a combination thereof, for example, the operations may be implemented, comprising one or more processors or controllers under computer program control for performing operations described herein, for example, an apparatus comprising at least one processor, and at least one memory including computer program code, the at least one memory and the computer program code configured to, with the at least one processor, cause the apparatus at least to perform defined functions and/or operations.

Merely for illustration, FIG. 8 indicates a representative aggregated probability distribution ŷ=G(F(xₜ)) for a notional batch of target data items xₜ when applied to the classifier 41. It is assumed that we take the upper and lower K classes. K=2 in this example. We then select source data samples xₛ associated/labelled with classes A and B for training the source predictor 43 for a label “1” or other high confidence label. Conversely, we select source data samples associated/labelled with classes D and E for training the source predictor 43 for a label “0” or other low confidence label. Source data samples associated/labelled with classes C and F are not used for training the source predictor 43.

FIG. 11 is a block diagram of an example source predictor 43. It may comprise a form of classifier computational model that is iteratively trained and, based in an input F(Xₛ) generates a source weight δ^{T} in the manner described above.

The example source predictor 43 may be implemented, for example, comprising one or more processors or controllers under computer program control for performing operations described herein, for example, an apparatus comprising at least one processor, and at least one memory including computer program code, the at least one memory and the computer program code configured to, with the at least one processor, cause the apparatus at least to perform defined functions and/or operations.

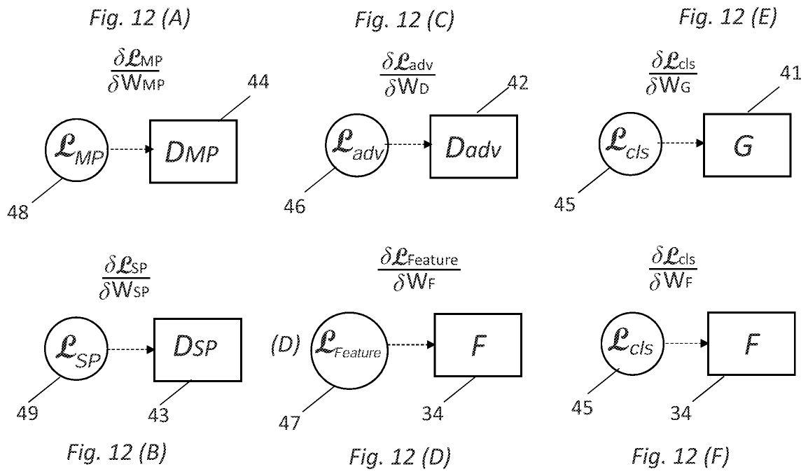

FIGS. 12A-12F are process flow diagrams indicating how the various computational sub models 34, 41, 42, 43, 44 described herein are iteratively updated by backpropagation. As will be appreciated in the field, computational models may be updated using descent techniques, e.g. gradient descent, to reduce a loss function.

The various computational sub models may be implemented, for example, comprising one or more processors or controllers under computer program control for performing operations described herein, for example, an apparatus comprising at least one processor, and at least one memory including computer program code, the at least one memory and the computer program code configured to, with the at least one processor, cause the apparatus at least to perform defined functions and/or operations.

FIGS. 12A-12F also indicate which loss functions 45, 46, 47, 48, 49 are used iteratively to update weights of the respective models in each round of updating.

For example, FIG. 12A indicates that the margin predictor 44 is updated based on the margin predictor loss function L_{MP} 48 using the delta of said loss function L_{MP} 48 divided by the delta of the margin predictor weights W_{MP}. FIG. 12B indicates that the source predictor 43 is updated based on the source predictor loss function L_{SP} 49 using the delta of said loss function L_{SP} 49 divided by the delta of the source predictor weights W_{SP}. FIG. 12C indicates that the discriminator 42 is updated based on the adversarial loss function L_{adv} 46 using the delta of said loss function Lady 46 divided by the delta of the discriminator weights W_{D}. FIG. 12D indicates that the feature extractor 34 is updated based on the feature loss function L_{Feature} 47 using the delta of said loss function L_{Feature} 47 divided by the delta of the feature extractor weights W_{F}. FIG. 12E indicates that the classifier 41 is updated based on the classifier loss function L_{Cls} 45 using the delta of said loss function L_{Cls} 45 divided by the delta of the classifier weights W_{G}. FIG. 12F indicates that the feature extractor 34 is also updated based on the classifier loss function L_{Cls} 45 using the delta of said loss function L_{Cls} 45 divided by the delta of the feature extractor weights W_{F}.

Inference Phase

In an inference phase, given a particular target data item Xₜ, sometimes referred to as a test data item, its feature representation is computed and provided to the margin predictor 44 to estimate whether is a shared (1) or private (0) class. If it is estimated as belonging to a private class then it is labelled as “unknown”. If it is estimated as a shared class, we compute using the classifier 41 the probability distribution ŷ and output argmax ŷ as its label.

System Architectures

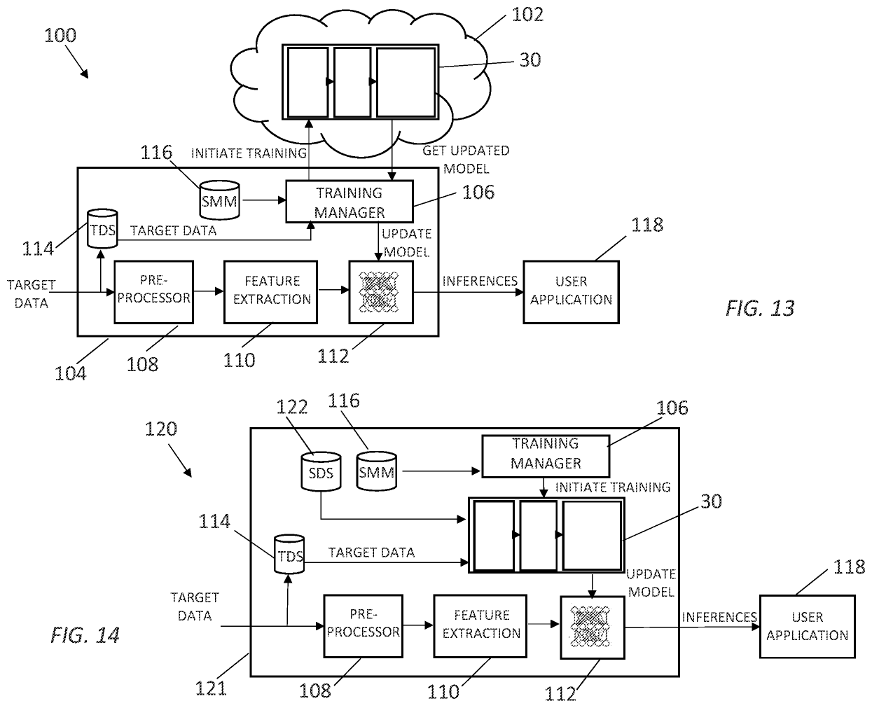

FIG. 13 shows an example system architecture 100 in which the adaptation system 30 may be implemented in a cloud network 102 associated with a source domain. A system associated with a target domain (“target system”) 104 may comprise a training manager 106, a pre-processor 108, a feature extractor 110, and an encoder 112 implementing a computational model which is updated by the adaptation system 30 according to example aspects. The target system 104 may also comprise a target data store 114 and a source metadata store 116. The target data store 114 may store received target data items, which are unlabeled. The source metadata store 116 may store metadata indicating its training conditions, e.g. on which camera source data was trained etc. or one or more other conditions or characteristics which can be received with the target data items and stored in the target data store 114. We can assume that source data items are provided in the cloud network 102.

Subsequently, the training manager 106 may be configured to read the source metadata store 116 and identify whether source conditions for a given source domain model are different from target conditions, e.g. above some measurable threshold, in order to enable or trigger adaptation of the source domain model.

Once source and target data items are available, the adaptation system 30 described above may function as described to perform pre-processing, feature extraction and then adaptation. The output is provided by the adaptation system 30 via the training manager 106 to update the current model stored on the encoder 112 which is then deployed, or made effective, for the inference stage whereby target data items can be received and labelled (inference output) as belonging to a particular class, or, if applicable, an unknown inference output is generated. During inference, target data items pass through the pre-processor 108, feature extractor 110 and updated model on the encoder 112 to produce either labelled or unknown inference output for some user application 118.

An example of inference output may include, for an audio (e.g. speech) model, a keyword or phrase based on received speech from a user. Another example of inference output may include, for a vision (e.g. video-based) model, a type of object present in an image. Another example of inference output may include, for an activity-based model, a particular physical activity performed by a user, e.g. running, walking, swimming.

FIG. 14 shows an example system architecture 120 in which the adaptation system 30 may be implemented at a system 121 associated with the target domain (“target system”). Similar to FIG. 13, the target system 121 may comprise a training manager 106, a pre-processor 108, a feature extractor 110, and an encoder 112 implementing a computational model which is updated by the adaptation system 30 according to example aspects. The target system 121 may also comprise a target data store 114, a source metadata store 116 and, additionally, a source data store 122 for receiving source data items. Otherwise, training and inference are performed as for the FIG. 13 embodiment. The benefit of this approach is that target data items need never leave the target system 121 and hence has privacy and security benefits.

The adaptation system 30 in the FIG. 13 or 14 may be performed on any of hardware, software, firmware or a combination thereof, for example, the operations may be implemented, comprising one or more processors or controllers under computer program control for performing operations described herein, for example, an apparatus comprising at least one processor, and at least one memory including computer program code, the at least one memory and the computer program code configured to, with the at least one processor, cause the apparatus at least to perform defined functions and/or operations.

Examples of target systems 104, 121 may include edge devices, such as a home gateway or router with a microphone, a camera and/or smartphone.

In example aspects, the source and target data items may be generated and/or received from one or more electrical or electronic sensors. A sensor may comprise one or more of a microphone, camera, video camera, light sensor, heat sensor, geospatial positioning sensor, orientation sensor, accelerometer and a physiological sensor such as for estimating heart rate, blood pressure, temperature, an electrocardiogram (ECG) or the like. During one or both of the adaptation and the inference stages, target data items may be received in real-time or near real-time. For the adaptation stage, source and target data items may be historical data items stored in one or more data memories.

### Specific Examples of Technical Purpose

Example aspects may comprise use of the adaptation system 30 shown in FIG. 3, and/or either of the example system architectures 100, 120 shown in FIGS. 13 and 14 respectively, for domain adaption for one or more of the following technical purposes.

For example, example aspects may involve audio classification, including, but not limited to speech classification. That is, a source computational model may be trained using a labelled dataset of spoken one or more keywords. The source computational model may comprise a keyword detection classifier. The keyword detection classifier may be configured for use in any computer-based apparatus or method which employs speech recognition based on one, or a sequence of keywords, and which may perform one or more actions in response thereto. An example may comprise a computerized digital assistant that responds to one or more keywords with one or more of an audio response and/or video output. The computerized digital assistant may additionally, or alternatively, perform one or more other responsive functions based on an inference output, such as requesting information, controlling one or more electronic systems or device, for example, a home automation, comprising a lighting, an alarm system and/or a heating system. The computerized digital assistant may be a standalone device or part of a vehicle or craft control system. The source computational model may have been trained using a labelled dataset representing a first spoken accent, e.g. an English accent. If the source computational model is to be deployed to a system for receiving speech in a second accent in the same or a similar language, e.g. a French-English accent, then the accent variability will likely cause domain shift for which the adaptation system 30 can provide an updated computational model.

For example, the source model metadata 116 indicated as stored in FIGS. 13 and 14 may indicate that the source computational model was trained using one or more keywords spoken in an English accent. The target data items may be associated with metadata indicating that the data items represent one or more keywords spoken in a French accent. The metadata may be provided manually or generated through some automated method, e.g. based on the identity of the person or entity providing the respective data items or using a detection algorithm or model. Domain adaptation may be performed based on identifying said differences in the metadata.

Other phenomena that may cause domain shift in audio/speech classification include, but are not limited to, differences in ambient noise, channel and/or microphone variability and other environmental factors. For example, microphones produced by different manufacturers may produce different audio characteristics. Source (and target) metadata may indicate such differences. A lookup table (LUT) may be accessed to determine whether if different devices have characteristics deemed sufficiently different to require domain adaptation.

Gender may also contribute towards domain shift. For example, if the source computational model is trained using a labelled dataset comprising one or more keywords spoken by one or more females and is to be deployed to a system for receiving speech spoken my males, then domain shift may result. Differences in age can also cause domain shift.

Hence, example aspects may be specifically employed as described herein for enabling adaption of a source computational model for audio (e.g. speech) classification to a target domain, whilst achieving the computational efficiencies disclosed herein.

Other example aspects may involve video classification, including, but not limited to object and/or gesture and/or movement classification. In this context, the term video may include both static and moving images.

For example, a source computational model may be trained using a labelled dataset of images or video clips. The source computational model may comprise an object classifier for identifying from, e.g. RGB pixel data, specific classes of object such as human, man, woman, child, dog, cat, car, boat etc.

In the case of humans, if the source computational model is trained on a particular type of person, e.g. healthy adult, domain shift may result if the target data items relate to different types of people, e.g. young people or even elderly people exhibiting signs of dementia, due to differences in their respective movements.

In all such video applications, variations between the source and target domains may be affected by phenomena such as ambient lighting conditions, camera type, and/or image capture parameters (e.g. sensor resolution, capture rate) for different sensor manufacturers etc.

Hence, example aspects may be specifically employed as described herein for enabling adaption of a source computational model for video classification to a target domain, whilst achieving the computational efficiencies disclosed herein.

Other example aspects may involve fitness or health-related computational models, such as those used to monitor health-related performances of people or even animals for self-assessment or professional evaluation purposes. If a source computational model is trained on a particular type of person, e.g. healthy adult female of a certain age, domain shift may result if the model if the target data items relate to a different type of person e.g. an elderly male.

Other example aspects may involve the use of motion sensors placed on a monitored object, e.g. a person. A source computational model may be trained to identify a particular type of physical activity based on a particular type of motion detected by one or more motion sensors. For example, a motion sensor may be comprised within a smartphone, fitness tracker or smartwatch. Where a user places the motion sensor on, or relative to, their body is a matter of personal preference. Some users prefer to place their smartphone in their thigh pocket, chest pocket or on an arm-band. The different placements may induce domain shift where the source computational model is trained with regard to the thigh pocket placement but is worn using a different placement, e.g. on an arm-band.

Hence, example aspects may be specifically employed as described herein for enabling adaption of a source computational model for fitness and/or health inferences to a target domain, whilst achieving the computational efficiencies disclosed herein.

Evaluation

Use of the above-described adaptation system 30 has been tested on a limited range of speech-based adaptation tasks with results indicating improvements in terms of accuracy gains in the order of between 7-15%.

Neural Networks

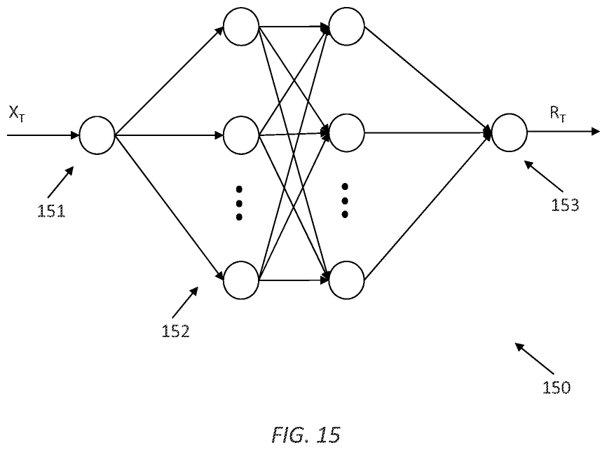

Many of the elements described above may be implemented using neural network technology. By way of example, FIG. 15 is a block diagram of a neural network system, indicated generally by the reference numeral 150, in accordance with an example embodiment. The example neural network system 150 is used, by way of example, to implement the target domain model described above. Similar neural network systems may be used to implement other modules described here (such as the feature extractor 34, classifier 41, margin predictor 44 and the source predictor 43).

The system 150 comprises an input layer 151, one or more hidden layers 152 and an output layer 153. At the input layer 151, input data (such as a portion of the target data set) may be received as inputs. The hidden layers 152 may comprise a plurality of hidden nodes, which may be connected in many different ways. At the output layer 153, output data (e.g. target encoder outputs) are generated.

The neural network of the system 150 comprises a plurality of nodes and a plurality of connections between those nodes. The neural network is trained by modifying the nodes, including modifying connections between the nodes and the weighting applied to such connections.

Hardware

For completeness, FIG. 16 is an example schematic diagram of components of one or more of the modules for implementing the algorithms in the target and/or the source domains described above, which hereafter are referred to generically as processing systems 300. A processing system 300 may have a processor 302, a memory 304 coupled to the processor and comprised of a RAM 314 and ROM 312, and, optionally, user inputs 310 and a display 318. The processing system 300 may comprise one or more network interfaces 308 for connection to a network, e.g. a modem which may be wired or wireless, such as local area network (LAN), wireless telecommunication network, such as 5G network, wireless short range communication network, such as wireless local area network (WLAN), Bluetooth®, ZigBee®, ultra-wideband connection (UWB), near field communication (NFC), IoT communication network/protocol such as a Low-Power Wide-Area Networking (LPWAN), a LoRaWANTM (Long Range Wide Area Network), Sigfox, NB-IoT (Narrowband Internet of Things), or similar. Further, the processing system 300 may comprise one or more sensors for generating input data, including, but not limited to, audio, image, video, motion sensors (such as gyroscopes and/or accelerometers), microphones, cameras, physiological sensors, etc. Further, the processing system 300 may comprise a global navigation satellite system (GNSS) sensor, such as a Global Positioning System (GPS) sensor.

The processor 302 is connected to each of the other components in order to control operation thereof.

The memory 304 may comprise a non-volatile memory, a hard disk drive (HDD) or a solid state drive (SSD). The ROM 312 of the memory 304 stores, amongst other things, an operating system 315 and may store software applications 316. The RAM 314 of the memory 304 is used by the processor 302 for the temporary storage of data. The operating system 315 may contain code which, when executed by the processor, implements aspects of the algorithms described herein, e.g. those indicated in flow diagrams.

The processor 302 may take any suitable form. For instance, it may be a microcontroller, plural microcontrollers, a processor, or plural processors. Processor 302 may comprise processor circuitry.

The processing system 300 may be a standalone computer, a server, a console, an apparatus, a user device, a mobile communication device, a smart phone, a vehicle, a vehicle telematics unit, a vehicle Electronic Control Unit (ECU), an IoT device, a sensor, a software application, a communication network, or any combination thereof.

In some example embodiments, the processing system 300 may also be associated with external software applications. These may be applications stored on a remote server device and may run partly or exclusively on the remote server device. These applications may be termed cloud-hosted applications. The processing system 300 may be in communication with the remote server device in order to utilize the software application stored there.

Some example embodiments of the present invention may be implemented in software, hardware, application logic or a combination of software, hardware and application logic. The software, application logic and/or hardware may reside on memory, or any computer media. In an example embodiment, the application logic, software or an instruction set is maintained on any one of various conventional computer-readable media. In the context of this document, a “memory” or “computer-readable medium” may be any non-transitory media or means that can contain, store, communicate, propagate or transport the instructions for use by or in connection with an instruction execution system, apparatus, or device, such as a computer.

Reference to, where relevant, “computer-readable storage medium”, “computer program product”, “tangibly embodied computer program” etc., or a “processor” or “processing circuitry” etc. should be understood to encompass not only computers having differing architectures such as single/multi-processor architectures and sequencers/parallel architectures, but also specialized circuits such as field programmable gate arrays FPGA, application specify circuits ASIC, signal processing devices and other devices. References to computer program, instructions, code etc. should be understood to express software for a programmable processor firmware such as the programmable content of a hardware device as instructions for a processor or configured or configuration settings for a fixed function device, gate array, programmable logic device, etc.

The one or more of the modules for implementing the algorithms in the target and/or the source domains described above, which hereafter are referred to generically as processing systems 300 may be performed on any of hardware, software, firmware or a combination thereof, for example, comprising one or more processors or controllers under computer program control for performing operations described herein, for example, an apparatus comprising at least one processor, and at least one memory including computer program code, the at least one memory and the computer program code configured to, with the at least one processor, cause the apparatus at least to perform defined functions and/or operations.

Alternatively, the one or more of the modules for implementing the algorithms in the target and/or the source domains described above, which hereafter are referred to generically as processing systems 300 may be performed by one or more circuitry. As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions), and
(c) hardware circuit(s) and or processor(s), such as a microprocessor(s) or a portion of a microprocessor(s), that requires software (e.g., firmware) for operation, but the software may not be present when it is not needed for operation.”

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

If desired, the different functions discussed herein may be performed in a different order and/or concurrently with each other. Furthermore, if desired, one or more of the above-described functions may be optional or may be combined. Similarly, it will also be appreciated that the flow diagrams of FIGS. 5, 6 and 9 are examples only and that various operations depicted therein may be omitted, reordered and/or combined.

It will be appreciated that the above described example embodiments are purely illustrative and are not limiting on the scope of the invention. Other variations and modifications will be apparent to persons skilled in the art upon reading the present specification.

Moreover, the disclosure of the present application should be understood to include any novel features or any novel combination of features either explicitly or implicitly disclosed herein or any generalization thereof and during the prosecution of the present application or of any application derived therefrom, new claims may be formulated to cover any such features and/or combination of such features.

Although various aspects of the invention are set out in the independent claims, other aspects of the invention comprise other combinations of features from the described example embodiments and/or the dependent claims with the features of the independent claims, and not solely the combinations explicitly set out in the claims.

It is also noted herein that while the above describes various examples, these descriptions should not be viewed in a limiting sense. Rather, there are several variations and modifications which may be made without departing from the scope of the present invention as defined in the appended claims.

1. Apparatus, comprising:
at least one processor; and
at least one memory including computer program code;
the at least one memory and the computer program code configured to, with the at least one processor, cause the apparatus at least to perform:
provide a source dataset comprising source data items associated with a source domain;
provide a target dataset comprising target data items associated with a target domain;
provide a first computational model associated with the source domain dataset, the first computational model being associated with source domain classes;
generate, for series of target data items xt input to the first computational model, a target weight δT indicative of a confidence value that said target data item belongs to a class which is shared with known classes of the first computational model;
generate, for series of source data items xs input to the first computational model, a source weight δS indicative of a confidence value that said source data item belongs to a known class of the first computational model, shared with the target domain;
train a discriminator to seek to decrease a discriminator loss function by the source and target data items xs xt, respectively weighted by the source and target weights δS, δT;
adapt at least part of the first computational model to generate a second computational model by the discriminator loss function; and
deploy the second computational model for use to receive one or more input data items associated with the target domain and to produce an inference output.

2. The apparatus of claim 1, wherein the source and target datasets comprise respective first and second sets of audio data items, and wherein the second computational model is an adapted audio classifier comprising at least one class shared with known classes of the first computational model.

3. The apparatus of claim 2, wherein the first set of audio data items represent audio data received under one or more first conditions and wherein the second set of audio data items represent audio data received under one or more second conditions, wherein the first and second conditions comprise differences in terms of their respective ambient noise and/or microphone characteristics.

4. The apparatus of claim 2, wherein the first and second sets of audio data items represent speech, e.g. one or more keywords.

5. The apparatus of claim 4, wherein the second computational model is configured for use with a digital assistant apparatus for performing one or more processing actions based on received speech associated with the target domain.

6. The apparatus of claim 1, wherein the source and target datasets comprise respective first and second sets of video data items, and wherein the second computational model is an adapted video classifier comprising at least one class shared with known classes of the first computational model.

7. The apparatus of claim 6, wherein the respective first and second sets of video data items represent video data received under first and seconds conditions, wherein the first and second conditions comprise differences in terms of their respective lighting, camera, and/or image capture characteristics.

8. The apparatus of claim 6, wherein the first set of video data items represent video data associated with movement of a first type of object and the second set of video data items represent video data associated with movement of a second type of object.

9. The apparatus of claim 1, wherein the source and target datasets comprise respective first and second physiological data items, received from one or more sensors, and wherein the second computational model is an adapted health or fitness-related classifier comprising at least one class shared with known classes of the first computational model.

10. The apparatus of claim 1, wherein the at least one memory and the computer program code are further configured to generate the target weight and the source weight by use of a probability distribution produced by input of one or more target data items to the first computational model.

11. The apparatus of claim 10, wherein the at least one memory and the computer program code are further configured to compute the target weight by use of a first classifier, that is a computational model trained using a filtered subset of the one or more target data items based on the produced probability distribution.

12. The apparatus of claim 11, wherein the at least one memory and the computer program code are further configured to provide the filtered subset of target data items by:
generate, using the first computational model, a probability distribution over the known source domain classes for a particular target data item;
determine a confidence level for the particular target data item belonging to a source domain class using the generated probability distribution; and
select the particular target data item for the subset if the confidence level is above an upper confidence level threshold or below a lower confidence level threshold.

13. The apparatus of claim 11, wherein the first classifier is further configured as a binary classifier to compute a target weight of ‘1’ for indicating that a particular target data item belongs to a shared target domain class and ‘0’ for indicating that a target data item belongs to a private target domain class.

14. The apparatus of claim 11, wherein the apparatus further comprises a second classifier configured to compute the source weight, the second classifier being a computational model trained using a filtered subset of the source domain data items.

15. The apparatus of claim 14, wherein the at least one memory and the computer program code are further configured to filter the source data items by:
input a batch of target data items to the first trained model to generate respective probability distributions;
aggregate the probability distributions;
identify a subset of the source domain classes based on the aggregated probability distributions, including a predetermined number of largest value and lowest value classes; and
select source data items associated with the identified subset of source domain classes.

16. The apparatus of claim 14, wherein the second classifier is configured as a binary classifier for computing a source weight of ‘1’ for indicating that a particular source data item belongs to a known class of the first computational model shared with the target domain and ‘0’ for indicating that a particular source data item belongs to a private source domain class.

17. The apparatus of claim 1, wherein the first computational model comprises a feature extractor associated with the source domain dataset, and wherein the adapting of the first computational model further comprises: update weights of the feature extractor based on the computed discriminator loss function.

18. The apparatus of claim 17, wherein the first computational model further comprises a classifier for receiving feature representations from the feature extractor, and wherein the adapting of the first computational model further comprises: determine a classification loss resulting from updating weights of the feature extractor and updating the weights of the feature extractor based on the classification loss.

19. The apparatus of claim 1, wherein the at least one memory and the computer program code are further configured to adapt the first computational model responsive to an identification that one or more conditions under which the set of target data items were produced are different from one or more conditions under which the set of source data items were produced.

20. The apparatus of claim 19, wherein the at least one memory and the computer program code are further configured to identify different characteristics of one or more sensors used for generating the respective sets of target data items and source data items.

21. The apparatus of claim 19, wherein the at least one memory and the computer program code are further configured to access metadata respectively associated with the source and target data items indicative of the one or more conditions under which the sets of source and target data items were produced.

22. A method, comprising:
providing a source dataset comprising a plurality of source data items associated with a source domain;
providing a target dataset comprising a plurality of target data items associated with a target domain;
providing a first computational model associated with the source domain dataset, the first computational model being associated with a plurality of source domain classes;
generating, for each of a series of target data items xt input to the first computational model, a target weight δT indicative of a confidence value that said target data item belongs to a class which is shared with known classes of the first computational model;
generating, for each of a series of source data items xs input to the first computational model, a source weight δS indicative of a confidence value that said source data item belongs to a known class of the first computational model (34, 41), shared with the target domain;
adapting at least part of the first computational model to generate a second computational model by training a discriminator (42) to seek to decrease a discriminator loss function, the discriminator loss function being computed using the source and target data items xs xt, respectively weighted by the source and target weights δS, δT; and
deploying the second computational model for use in receiving one or more input data items associated with the target domain for producing an inference output.
